(19) United States
(12) Patent Application Publication
(10) Pub. No.: US 2014/0244583 A1
(43) Pub. Date: Aug. 28, 2014

(54) Method of Processing File changes and Electronic Device Thereof

(71) Applicant: Wistron Corporation, New Taipei City (TW)

(72) Inventors: Fuming Wang, New Taipei City (TW); Ke-An Chen, New Taipei City (TW)

(73) Assignee: Wistron Corporation, New Taipei City (TW)

(21) Appl. No.: 14/083,402

(22) Filed: Nov. 18, 2013

(30) Foreign Application Priority Data
Feb. 22, 2013 (CN) 201310057195.9

(51) Int. Cl. G06F 17/30

(52) U.S. Cl. CPC G06F 17/30368
USPC 707/625

(57) ABSTRACT

A method of processing files changes includes obtaining a change list of a designate folder, wherein the designate folder includes a plurality of sub-files changed in a time segment and the change list indicates filenames, pathnames and change times corresponding to the plurality of sub-files, determining whether a system time minus a last change time indicated by the change list is greater than a time threshold, and executing a process of determining file actions according to the change list to store a process result in a file action list when the system time minus the last change time indicated by the change list is greater than the time threshold.

### BACKGROUND OF THE INVENTION

1. Field of the Invention

The present invention relates to a method of processing file changes and electronic device thereof, and more particularly, to a method of processing file changes and electronic device thereof capable of simplifying comprehensive process to the file changes to improve an efficiency of analyzing file actions.

2. Description of the Prior Art

An online file synchronization service provider (hereafter called server) enables a user to synchronize files or folders into online storages, and thus the user (hereafter called client) may access the files or folders stored in the online storages at anytime and location through the Internet.

However, a file manger of the server sometimes may require records, at an end of a time segment, of the files or folders stored in the online storage to perform user behavior analysis or logical processing. In some circumstances, the file manger may analyze file actions performed by the client by comprehensive processing over all of the file changes. For example, the file action may include rename, add, delete and update actions. If continuous, frequent or irregular file changes came, the comprehensive processing may be complicated and uncontrollable to lower a processing efficiency.

Therefore, there is a need to design a method of processing file changes to simplify the comprehensive processing to the file changes and improve the processing efficiency.

### SUMMARY OF THE INVENTION

It is therefore an objective of the present invention to provide a method of processing file changes to simplify the comprehensive processing to the file changes and improve the processing efficiency.

The present invention discloses a method of processing files changes. The method includes obtaining a change list of a designate folder, wherein the designate folder includes a plurality of sub-files changed in a time segment and the change list indicates filenames, pathnames and change times corresponding to the plurality of sub-files, determining whether a system time minus a last change time indicated by the change list is greater than a time threshold, and executing a process of determining file actions according to the change list to store a process result in a file action list when the system time minus the last change time indicated by the change list is greater than the time threshold.

The present invention further discloses an electronic device. The electronic device includes a processor and a storage coupled to the processor for storing a program code instructing the processor to execute a method of processing files changes, the method includes obtaining a change list of a designate folder, wherein the designate folder includes a plurality of sub-files changed in a time segment and the change list indicates filenames, pathnames and change times corresponding to the plurality of sub-files, determining whether a system time minus a last change time indicated by the change list is greater than a time threshold, and executing a process of determining file actions according to the change list to store a process result in a file action list when the system time minus the last change time indicated by the change list is greater than the time threshold.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of an electronic device according to an embodiment of the present invention embodiment.

FIG. 2 is a schematic diagram of a process of processing file changes according to an embodiment of the present invention.

FIG. 3A and FIG. 3B are schematic diagrams of a process of determining file actions according to an embodiment of the present invention.

### DETAILED DESCRIPTION

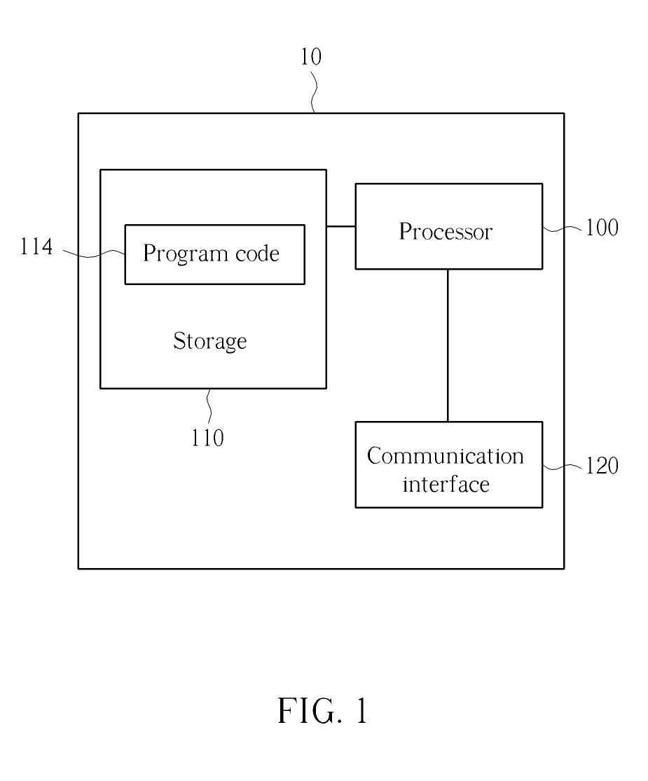

Please refer to FIG. 1, which is a schematic diagram of an electronic device 10 according to an embodiment of the present invention. The electronic device 10 may be a personal computer, a smart phone, a tablet PC, a personal digital assistant or a laptop. The electronic device 10 may be connected with a server through the Internet to enable an online file synchronization service to a client. The electronic device 10 includes a processor 100, a storage 110 and a communication interface 120. The processor 100 may be coupled to the storage 110. The processor 100 may be such as a microprocessor or an application-specific integrated circuit (ASIC). The storage 310 may be any data storage device for storing a program code 114 for the processor 100 to access. For example, the storage 110 may be a subscriber identity module (SIM), a read-only memory (ROM), a random-access memory (RAM), CD-ROMs, magnetic tapes, a hard disk or optical data storage device, and not limited to the mentioned storage devices. The communication interface 120 is used for exchanging data packets with other electronic devices by wired or wireless signals according to process results of the processor 100.

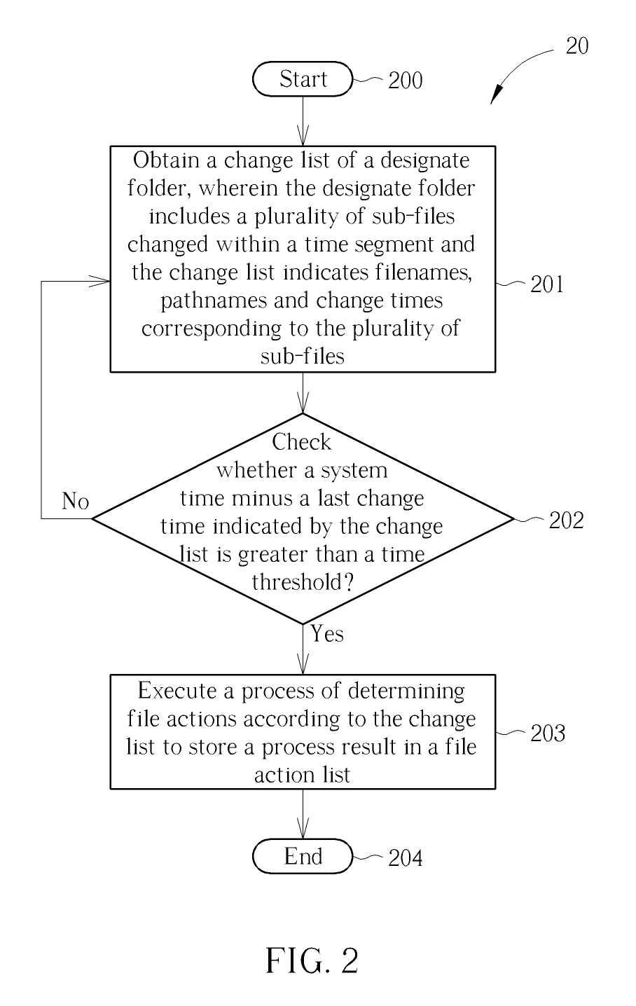

Please refer to FIG. 2 for operations of the electronic device 10. FIG. 2 is a schematic diagram of a process of processing file changes 20 according to an embodiment of the present invention. The process of processing file changes 20 may be used in the electronic device 10 for obtaining records of file changes performed by the client. The process of processing file changes 20 may be compiled into the program code 114 and include the following steps:

Step 200: Start.

Step 201: Obtain a change list of a designate folder, wherein the designate folder includes a plurality of sub-files changed within a time segment and the change list indicates filenames, pathnames and change times corresponding to the plurality of sub-files.

Step 202: Go to Step 203 if a system time minus a last change time indicated by the change list is greater than a time threshold. Return to Step 201 if the system time minus the last change time indicated by the change list is less than the time threshold.

Step 203: Execute a process of determining file actions according to the change list to store a process result in a file action list.

Step 204: End.

In the process of processing file changes 20, the change list may be generated by a file monitoring application from a third party other than the client and the server, and the file monitoring application may be installed in the client for monitoring instant file changes performed by the client. For example, WiSync™ is a file monitoring application to record one by one file changes performed by the client, and be able to upload the file changes to the server by certain communication protocols. If the client is offline, WiSync™ may keep recording the file changes, by the time that the connection between the client and the server is available, WiSync™ may upload the file changes as usual.

Accordingly, in order to simplify the work to process file changes, the process of processing file changes 20 of the present invention is to obtain a change list generated by the file monitoring application in the client to perform comprehensive process to the file changes, so as to determine file actions that the client has performed and store the process results in a file action list. Hence, the file action list may be uploaded to the server when the connection between the client and the server is available, which may reduce a burden of the server to process file changes and improve the processing efficiency of the server.

Noticeably, whether the file actions performed by the client have come to an end may be determined according to a time threshold. Specifically, if the time threshold has not elapsed since a last change time indicated by the change list, which may be assumed that the file actions performed by the client have not come to an end, thereby the client may keep doing file actions during the time threshold. On the other hand, if the time threshold has elapsed since the last change time indicated by the change list, which may be assumed that the file actions performed by the client have come to an end, new file actions may not be performed by the client for a while. In other words, if a system time T_{SVS} of the client minus a last change time T_{LAST} indicated in the change list is less than a time threshold T_{TH}, i.e. T_{SYS}−T_{LAST}<T_{TH}, the file monitoring application may possibly generate or discover file changes to keep updating the change list of the designate folder, and thus the process of determining file actions maybe deactivated. On the contrary, if the system time T_{SYS} of the client minus the last change time T_{LAST} of the change list is greater than the time threshold T_{TH}, i.e. T_{SYS}−T_{LAST}>T_{TH}, which means the file changes performed by the client have come to an end, and thereby the process of determining file actions maybe activated. As a result, activations of the process of determining file actions may be controlled according to the time threshold T_{TH}. When continuous file changes come, the process of determining file actions may be deactivated to relieve system resources of the client. On the contrary, when the process of determining file actions is activated, Step 201 and Step 202 are preferably deactivated to stop checking the time threshold T_{TH}. Meanwhile, the file monitoring application may keep updating the change list of the designate folder. Subsequently, Step 201 and Step 202 maybe activated to check the time threshold T_{TH} after the process of determining file actions is finished.

Therefore, the process of processing file changes 20 may be regarded as a loop program for repeatedly obtaining the records of file changes, i.e. filenames, pathnames and change times, performed by the client to accordingly perform the process of determining file actions, and store the process results in the store file action list, and the file action list may be uploaded to the server. As a result, as long as the connection between the client and the server is available, the process of processing file changes 20 may instantly update the records of file changes and the file actions to the server.

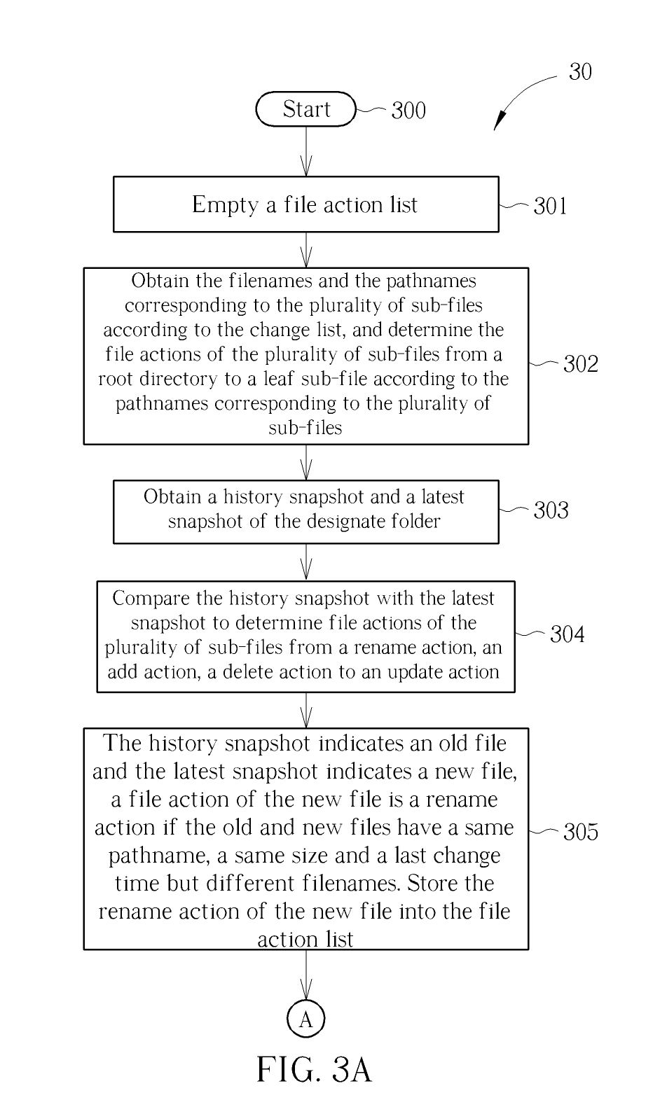

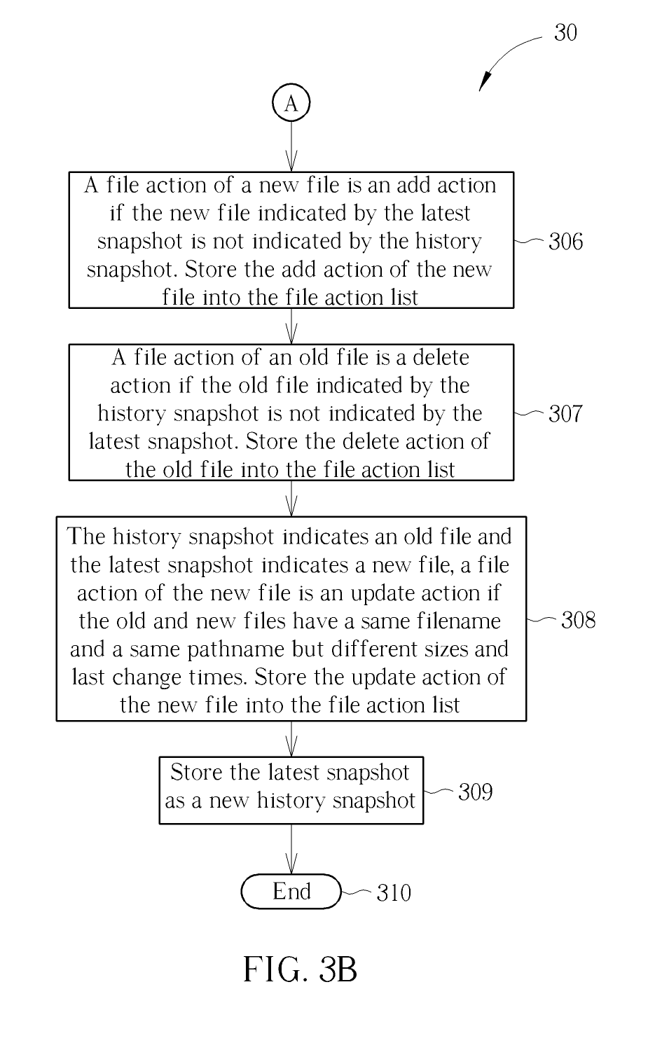

Please refer to FIG. 3A and FIG. 3B for operations of the process of determining file actions. FIG. 3A and FIG. 3B are schematic diagrams of a process of determining file actions 30 according to an embodiment of the present invention. The process of determining file actions 30 may be executed for logic analysis to the file changes, so as to determine what actions that the client has done to the files. For example, the action may be a rename action, an add action, a delete action and an update action. The process of determining file actions 30 may be compiled into the program code 114 as well, and include the following steps, wherein Step 300 to Step 305 are illustrated in FIG. 3A and Step 306 to Step 310 are illustrated in FIG. 3B:

Step 300: Start.

Step 301: Empty a file action list.

Step 302: Obtain the filenames and the pathnames corresponding to the plurality of sub-files according to the change list, and determine the file actions of the plurality of sub-files from a root directory to a leaf sub-file according to the pathnames corresponding to the plurality of sub-files.

Step 303: Obtain a history snapshot and a latest snapshot of the designate folder.

Step 304: Compare the history snapshot with the latest snapshot to determine file actions of the plurality of sub-files from a rename action, an add action, a delete action to an update action.

Step 305: The history snapshot indicates an old file and the latest snapshot indicates a new file, a file action of the new file is a rename action if the old and new files have a same pathname, a same size and a last change time but different filenames. Store the rename action of the new file into the file action list.

Step 306: A file action of a new file is an add action if the new file indicated by the latest snapshot is not indicated by the history snapshot. Store the add action of the new file into the file action list.

Step 307: A file action of an old file is a delete action if the old file indicated by the history snapshot is not indicated by the latest snapshot. Store the delete action of the old file into the file action list.

Step 308: The history snapshot indicates an old file and the latest snapshot indicates a new file, a file action of the new file is an update action if the old and new files have a same filename and a same pathname but different sizes and last change times. Store the update action of the new file into the file action list.

Step 309: Store the latest snapshot as a new history snapshot.

Step 310: End.

In Step 301, since the process of determining file actions 30 is part of the loop program, i.e. the process of processing file changes 20, old process results of the process of determining file actions 30 must be emptied or cleaned before executing the next process of determining file actions 30, such that the old process results and new process results may not be stored in a same memory block, which may prevent the client from uploading the old process results to the server.

In Step 303 and Step 309, the latest snapshot of the designate folder may be stored as a history snapshot for the next process of determining action 30. In other words, a history snapshot currently in use is a latest snapshot previously in use for determining the file actions. Simply speaking, Step 303 is to compare old and new snapshots within a certain time segment to analyze the file actions accordingly. The time segment maybe an interval between two processes of determining action 30, or an interval that the client is continuously performing file changes.

For example, assume the time threshold is one minute, if the client performs file changes to the designate folder or sub-files in the designate folder from system time 1:00 to 1:10, and there is no file changes detected by the process of processing file changes 20 during system time 1:10 to 1:11. In such a situation, a latest snapshot at system time 1:11 may be compared with a history snapshot (assuming) at system time 00:50, herein a time segment is twenty-one minutes, i.e. a time difference between 00:50 to 1:11. If a latest snapshot is taken at system time 1:18 for the next process of processing file changes 20, the latest snapshot at system time 1:18 may be compared with the history snapshot at system time 1:11 to execute the next process of determining file actions 30, wherein the time segment is seven minutes. As a result, the process of processing file changes 20 and the process of determining file actions 30 may occasionally or regularly be activated to determine the file actions of the file changes as long as the file actions performed by the client come to an end, and the file actions of the file changes may be uploaded to the server accordingly. Meanwhile, the latest snapshot for the process of determining file actions may be stored to be the history snapshot for the next process of determining file actions, which may ensure data integrity of the files.

In Step 304, the rename action should be determined first, while the add, delete, and update actions may be determined later, and orders between determining the add, delete, and update actions may be switched according to practical requirements. Since the rename action is substantially to add a new file/folder after an old file/folder is deleted, it is required to determine the rename action first to prevent misjudging the delete and add actions from the rename action.

Please refer to Table 1 to Table 4, which respectively illustrate exemplary data of the change list, the history snapshot, the latest snapshot and the file action list to specifically describe operations of Step 305 to Step 308 in the process of determining file actions 30.

TABLE 1
Change list

| Pathname and Filename | Change time |
|---|---|
| C:\My WiSync\A\a.txt | 16:10:10 |
| C:\My WiSync\AB\b.txt | 16:10:11 |
| C:\My WiSync\A\AB\a.txt | 16:10:15 |
| C:\My WiSync\B\b.txt | 16:10:50 |

TABLE 2
History snapshot

| Pathname and Filename | Size | Change time |
|---|---|---|
| C:\My WiSync\A\a.txt | 12k | 16:08:17 |
| C:\My WiSync\AB\b.txt | 10k | 16:10:11 |
| C:\My WiSync\A\AB\b.txt | 33k | 16:10:15 |
| C:\My WiSync\AB\c.txt | 24k | 15:30:04 |

TABLE 3
Latest snapshot

| Pathname and Filename | Size | Change time |
|---|---|---|
| C:\My WiSync\A\a.txt | 10k | 16:10:10 |
| C:\My WiSync\A\AB\a.txt | 33k | 16:10:15 |
| C:\My WiSync\B\b.txt | 26k | 16:10:50 |
| C:\My WiSync\AB\c.txt | 24k | 15:30:04 |

TABLE 4
File action list

| File action | Pathname and Filename |
|---|---|
| Rename action | C:\My WiSync\A\AB\a.txt |
| Add action | C:\My WiSync\B\b.txt |
| Delete action | C:\My WiSync\AB\b.txt |
| Update action | C:\My WiSync\A |
| | C:\My WiSync\A\AB |
| | C:\My WiSync\A\a.txt |
| | C:\My WiSync\AB |
| | C:\My WiSync\B |

According to Step 305, the history snapshot and the latest snapshot may respectively indicate:

an old file C:\My WiSync\A\AB\b.txt, and

a new file C:\My WiSync\A\AB\a.txt, the new and old files have a same pathname C:\My WiSync\A\AB, a same size 33 k, and a same change time 16:10:15, but have different filenames b and a. Therefore, a file action of the new file C:\My WiSync\A\AB\a may be determined to be a rename action, i.e. the filename b is changed to be the filename a.

According to Step 306, a new file C:\My WiSync\B\b.txt indicated by the latest snapshot is not indicated by the history snapshot. Therefore, a file action of the new file C:\My WiSync\B\b.txt may be determined to be an add action.

According to Step 307, an old file C:\My WiSync\AB\b.txt indicated by the history snapshot is not indicated by the latest snapshot. Therefore, a file action of the old file C:\My WiSync\AB\b.txt may be determined to be a delete action.

According to Step 308, the history snapshot and the latest snapshot respectively indicate:

an old file C:\My WiSync\A\a.txt, and

a new file C:\My WiSync\A\a.txt, the old and new files have a same pathname C:\My WiSync\A and a same filename a, but different sizes 12 k and 10 k, different change times 16:08:17 and 16:10:10. Therefore, a file action of the new file C:\My WiSync\A\a.txt may be determined to be an update action.

In addition, a file C:\My WiSync\AB\c.txt indicated by both of the history snapshot and the latest snapshot, whose pathname, size and change time remain the same, thereby the file C:\My WiSync\AB\c.txt is not processed by the process of determining file actions 30. In other words, although the file C:\My WiSync\AB\c.txt is included in the designated folder My WiSync but is not recorded in the change list in Table 1, which means the file C:\My WiSync\AB\c.txt is not changed by the client. Therefore, there is no need to perform the process of determining file actions 30 to the file C:\MyWiSync\AB\c.txt. The process of determining file actions 30 may be performed on files which are changed by the client.

In Step 302, determining a file action of a sub-file may start from a root directory or an upper directory to which the sub-file is belonged. The root directory may be the designate folder itself or another sub-file in the designate folder. As shown in Table 4, Table 4 lists pathnames and filenames of the sub-files being changed or relative to changes performed by the client.

To sum up, in order to simplify the work of the server to process file changes, the present invention is to occasionally obtain records of file changes, i.e. filenames, pathnames and change times of the files being changed, to accordingly perform the process of determining file actions and store the process results in a file action list. Whether the file actions performed by the client have come to an end may be determined according to a time threshold to activate or deactivate the process of determining file actions, so as to relieve system resources of the client. As a result, as long as the connection between the client and the server is available, the client may instantly update the records of file changes and the file actions to the server, and thus simplifies the work of the server to process file changes.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method of processing files changes, comprising:
obtaining a change list of a designate folder, wherein the designate folder includes a plurality of sub-files changed in a time segment and the change list indicates filenames, pathnames and change times corresponding to the plurality of sub-files;
determining whether a system time minus a last change time indicated by the change list is greater than a time threshold; and
executing a process of determining file actions according to the change list to store a process result in a file action list when the system time minus the last change time indicated by the change list is greater than the time threshold.

2. The method of claim 1, wherein the process of determining file actions comprises:
obtaining the filenames and the pathnames corresponding to the plurality of sub-files according to the change list;
obtaining a history snapshot and a latest snapshot of the designate folder;
comparing the history snapshot with the latest snapshot to determine file actions of the plurality of sub-files in order according to the pathnames corresponding to the plurality of sub-files; and
storing the file actions of the plurality of sub-files in a file action list.

3. The method of claim 2, wherein the step of comparing the history snapshot with the latest snapshot to orderly determine file actions of the plurality of sub-files according to the pathnames corresponding to the plurality of sub-files comprises:
determining the file actions of the plurality of sub-files from a rename action, an add action, and a delete action to an update action.

4. The method of claim 3, wherein the history snapshot indicates an old file and the latest snapshot indicates anew file, a file action of the new file is a rename action if the old and new files have a same pathname, a same size and a last change time but different filenames.

5. The method of claim 3, wherein a file action of a new file is an add action if the new file indicated by the latest snapshot is not indicated by the history snapshot.

6. The method of claim 3, wherein a file action of an old file is a delete action if the old file indicated by the history snapshot is not indicated by the latest snapshot.

7. The method of claim 3, wherein the history snapshot indicates an old file and the latest snapshot indicates anew file, a file action of the new file is an update action if the old and new files have a same filename and a same pathname but different sizes and last change times.

8. The method of claim 2, wherein the step of comparing the history snapshot with the latest snapshot to determine file actions of the plurality of sub-files in order according to the pathnames corresponding to the plurality of sub-files comprises:
determining the file actions of the plurality of sub-files from a root directory to a leaf sub-file according to the pathnames corresponding to the plurality of sub-files.

9. The method of claim 2, wherein the process of determining file actions further comprises:
emptying the file action list.

10. The method of claim 2, wherein the process of determining file actions further comprises:
storing the latest snapshot as a new history snapshot.

11. An electronic device, comprising:
a processor; and
a storage coupled to the processor for storing a program code instructing the processor to execute a method of processing files changes, the method comprises:
obtaining a change list of a designate folder, wherein the designate folder includes a plurality of sub-files changed in a time segment and the change list indicates filenames, pathnames and change times corresponding to the plurality of sub-files;
determining whether a system time minus a last change time indicated by the change list is greater than a time threshold; and
executing a process of determining file actions according to the change list to store a process result in a file action list when the system time minus the last change time indicated by the change list is greater than the time threshold.

12. The electronic device of claim 11, wherein the process of determining file actions comprises:
obtaining the filenames and the pathnames corresponding to the plurality of sub-files according to the change list;
obtaining a history snapshot and a latest snapshot of the designate folder;
comparing the history snapshot with the latest snapshot to determine file actions of the plurality of sub-files in order according to the pathnames corresponding to the plurality of sub-files; and
storing the file actions of the plurality of sub-files in a file action list.

13. The electronic device of claim 12, wherein the step to comparing the history snapshot with the latest snapshot to orderly determine file actions of the plurality of sub-files according to the pathnames corresponding to the plurality of sub-files comprises:
determining the file actions of the plurality of sub-files from a rename action, an add action, and a delete action to an update action.

14. The electronic device of claim 13, wherein the history snapshot indicates an old file and the latest snapshot indicates anew file, a file action of the new file is a rename action if the old and new files have a same pathname, a same size and a last change time but different filenames.

15. The electronic device of claim 13, wherein a file action of a new file is the add action if the new file indicated by the latest snapshot is not indicated by the history snapshot.

16. The electronic device of claim 13, wherein a file action of an old file is a delete action if the old file indicated by the history snapshot is not indicated by the latest snapshot.

17. The electronic device of claim 13, wherein the history snapshot indicates an old file and the latest snapshot indicates anew file, a file action of the new file is an update action if the old and new files have a same filename and a same pathname but different sizes and last change times.

18. The electronic device of claim 12, wherein the step of comparing the history snapshot with the latest snapshot to determine file actions of the plurality of sub-files in order according to the pathnames corresponding to the plurality of sub-files comprises:
determining the file actions of the plurality of sub-files from a root directory to a leaf sub-file according to the pathnames corresponding to the plurality of sub-files.

19. The electronic device of claim 12, wherein the process of determining file actions further comprises:
emptying the file action list.

20. The electronic device of claim 12, wherein the process of determining file actions further comprises:
storing the latest snapshot as a new history snapshot.
